(19) United States
(12) Patent Application Publication
(10) Pub. No.: US 2010/0185521 A1
(43) Pub. Date: Jul. 22, 2010

(54) System and Method for Sponsoring Reduction of Harmful Emissions to the Atmosphere

(76) Inventor: Gary Lewis, Pincher Creek (CA)

Correspondence Address: ADE & COMPANY INC., 2157 Henderson Highway, WINNIPEG, MB, R2G1P9, CA

(21) Appl. No.: 12/597,688

(22) PCT Filed: Apr. 25, 2008
(86) PCT No.: PCT/CA08/00782

§ 371 Date: Apr. 5, 2010

Related U.S. Application Data
(60) Provisional application No. 60/913,863, filed on Apr. 25, 2007.

(51) Int. Cl. G06Q 50/00; G06Q 40/00; G06Q 30/00; G06Q 90/00

(52) U.S. Cl. 705/17; 705/500

(57) ABSTRACT

Sponsoring reduction of carbon dioxide in the atmosphere comprises identifying an agricultural activity which reduced carbon dioxide in the atmosphere, collecting a voluntary sponsored amount from a purchaser of a fossil fuel, and using the sponsored amount to fund the agricultural activity. The sponsored amount is associated with a unit area of land which is used for agriculture so that the purchaser of fuel who sponsors funds can better identify with use of the funds. The purchaser may be provided with points in an account in exchange for the sponsored amount in which points are debited from the account upon purchasing the fossil fuel, for example for consumption in a vehicle.

This application claims priority to U.S. provisional application Ser. No. 60/913,863, filed Apr. 25, 2007.

### FIELD OF THE INVENTION

The present invention relates to a system and method for collecting a sponsored amount from a consumer of fossil fuels to be used for funding various activities which contribute to the reduction of harmful emissions, for example carbon dioxide, in the atmosphere.

### BACKGROUND

Pollution of the environment, including harmful emissions to the atmosphere, is a matter of increasing concern to many persons and organisations.

One example of a possible solution to reduce pollution involves the production of a Hydrogen fuel using only sunlight and water to provide infinite, clean and renewable fuel referred to by the trademark name Photo Fuel™. In the making of Photo Fuel™, a natural photosynthetic process is mimicked whereby the chlorophyll in green plants is able to capture light energy (photons) and immediately convert that energy into a usable form for green plants. The hydrogen fuel production technology is based on this phenomenon, whereby photonic energy is captured and efficiently converted to electrical energy. The electrical energy is used to drive downstream reactions that will efficiently split water into hydrogen and oxygen in a technology referred to as Chemophyll™

Although various solutions have been proposed to curb the effects of pollution, typical solutions involve costs which are commonly not incurred by the persons responsible for contributing to the pollution and accordingly there is often little or no motivation for these solutions to be implemented.

US Patent Application Publication US2004/0158478 to Zimmerman relates to a method and apparatus for determining carbon emission reduction credits and, more particularly, to a method and apparatus for generating and quantifying standardized carbon emission reduction credits. General data and site-specific data, if available, are input into a carbon sequestration model to determine the approximate change in the level of carbon compounds stored in a media, such as soil, over a specified period of time. An uncertainty analysis is conducted on the results to quantify and normalize carbon emission reduction credits. Standardized carbon emission reduction credits may be compiled for trade and other carbon emission reduction credits are placed in reserve.

U.S. Pat. No. 6,115,672 to Caveny et al. relates to carbon sequestration of greenhouse gases (carbon dioxide and methane) being effected through enhancement of plant growth using defoliation techniques with and without grazing animals. Processes and devices for measurement of the verifiable quantity of carbon sequestered are disclosed.

U.S. Pat. No. 7,343,341 to Sandor et al. relates to systems and methods for facilitating trading of emission allowances and offsets among participants. In some embodiments, methods of facilitating such trading include establishing an emissions reduction schedule for certain participants based on emissions information provided by those participants and determining debits or credits for each participant in order to achieve the reduction schedule

The methods disclosed in US Patent Application Publication US2004/0158478 to Zimmerman, U.S. Pat. No. 6,115,672 to Caveny et al., and U.S. Pat. No. 7,343,341 to Sandor et al. do not promote or offer any opportunity for average consumers of fossil fuels, for example persons with vehicles having an internal combustion engine, to contribute funds to be used to promote more environmentally friendly agriculture.

### SUMMARY OF THE INVENTION

According to one aspect of the invention there is provided a method of sponsoring reduction of carbon dioxide in the atmosphere, the method comprising:

identifying at least one activity which reduces carbon dioxide in the atmosphere;

collecting a sponsored amount from a purchaser of a fossil fuel; and

using at least a portion of the sponsored amount to fund at least a portion of said at least one activity.

By collecting a sponsored amount from purchasers of fossil fuels who are responsible for consuming the fossil fuels which produce carbon dioxide, persons responsible for contributing to pollution can be provided with a means to fund at least a portion of a solution to their contribution to pollution. In particular, a typical commuter having a vehicle with an internal combustion engine may consume a particular amount of fossil fuel each season which in turn generates carbon dioxide in the atmosphere. By associating a sponsored amount to a particular plot of land, persons sponsoring carbon dioxide reducing activities obtain more satisfaction with regard to the amount sponsored and in turn feel more responsible to continue sponsoring further carbon dioxide reduction.

The purchaser can provide a sponsored amount to the system according to the present invention which assigns points to the purchaser of fossil fuels in an account from which the points are debited at each purchase of fossil fuel. The purchaser can then keep track of their purchase of fossil fuel to ensure that they are contributing a sufficient sponsored amount to offset their contribution to pollution of the atmosphere. The sponsored amount can then in turn be used by farmers or other persons involved in activities which can potentially reduce carbon dioxide. In agriculture for instance the sponsored amount received by the farmer can be used to purchase suitable equipment and the like for performing some of the following activities including incorporating emissions into the soil, using more environmentally friendly fuels, avoiding the use of salts applied to the soil where possible, managing plants shoot to root ratio to favour roots, selecting crop varieties more effective at consuming carbon dioxide, properly irrigating crops and relying on other agricultural equipment development including irrigation motors, combines, swathers, sprayers, forage harvesters and lawn mowers.

Preferably the sponsored amount is associated with a designated portion of said at least one activity and information relating to said at least one activity associated with the sponsored amount is provided to the purchaser.

The purchaser may be a purchaser of fossil fuel for use in vehicle, or of fossil fuel for all energy needs of the consumer, who voluntarily contributes the sponsored amount.

When collecting the sponsored amount to correspond with an amount of fossil fuel consumed in a vehicle over prescribed period of time, the prescribed period of time may correspond to a growing season.

Preferably the sponsored amount is proportional to the amount of fuel being purchased by the purchaser for consumption over a given period of time.

When the purchaser purchases a fuel amount of fuel for consumption, the fuel amount is preferably correlated to a given amount of carbon dioxide when consumed. In this instance, the method may include determining a prescribed level of said at least one activity required to reduce carbon dioxide in the atmosphere by the given amount and arranging the sponsored amount to fund said prescribed level of said at least one activity.

The sponsored amount may be debited from the purchaser at a point of sale of the fuel being purchased. When the sponsored amount corresponds to a fuel amount, only a portion of the fuel amount is typically purchased by the purchaser at a given time.

When the activity comprises an agricultural activity which contributes to a reduction in carbon dioxide in the atmosphere, the method preferably includes using at least a portion of the sponsored amount to fund at least a portion of said agricultural activity. The agricultural activity preferably comprises a change of practice in agriculture to reduce carbon dioxide in the atmosphere.

The sponsored amount may be associated with a unit area of land which is used for agriculture.

The purchaser may sponsor another unit area of land once a fuel amount has been purchased which corresponds to the previously sponsored amount or may increase the sponsored amount per unit area of land once a fuel amount has been purchased which corresponds to the previously sponsored amount. Accordingly, the sponsored amount may be increased per unit area of land when a level of activity reducing carbon dioxide in the atmosphere is increased per unit area of land.

Preferably information relating to said unit area of land is provided to the purchaser of fossil fuel who contributes the sponsored amount associated with the unit area of land.

The activity is preferably verified by a party other than the purchaser or a recipient of the sponsored amount to ensure the activity contributes to the reduction of carbon dioxide in the atmosphere.

The purchaser may select the unit area of land to be associated with said at least one activity from a plurality of unit areas of land to be selected.

The plurality of unit areas of land may be rated according to a potential contribution in reduction of carbon dioxide by the land or according to crop type.

Preferably the rating is verified by a party other than the purchaser or a recipient of the sponsored amount.

There may be provided an internet interface through which the purchaser selects the unit area of land.

The agricultural activity which is sponsored may comprise: incorporating exhaust emissions from agricultural equipment into the soil, use of fuel from renewable energy sources in agricultural equipment, managing a shoot to root ratio of plants to favour roots, changing a variety of crop being planted on a given unit area of land, and/or irrigating crops on a given unit area of land.

The method may include providing the purchaser with points in an account in exchange for the sponsored amount and debiting points from the account of the purchaser upon purchasing the fossil fuel.

The points may be debited from the account at a point of purchase of the fossil fuel by providing the purchaser with a debit card and swiping the debit card at the point of purchase of the fossil fuel.

Points may be credited on the account by increasing the sponsored amount through an internet interface and points may be debited on the account according to an amount of fossil fuel purchased through an internet interface.

According to another aspect of the present invention there is provided a method of sponsoring reduction of carbon dioxide in the atmosphere, the method comprising:

identifying a purchaser of fossil fuel;

collecting a sponsored amount from the purchaser of fossil fuel;

identifying an agricultural activity which contributes to a reduction in carbon dioxide in the atmosphere;

using at least a portion of the sponsored amount to fund at least a portion of said agricultural activity.

According to a further aspect of the present invention there is provided a method of sponsoring reduction of carbon dioxide in the atmosphere, the method comprising:

identifying at least one activity which reduces carbon dioxide in the atmosphere;

collecting a sponsored amount from a purchaser of a fossil fuel;

using at least a portion of the sponsored amount to fund at least a portion of said at least one activity;

providing the purchaser with points in an account in exchange for the sponsored amount;

debiting points from the purchaser upon purchasing the fossil fuel.

One embodiment of the invention will now be described in conjunction with the accompanying drawings in which:

### BRIEF DESCRIPTION OF THE DRAWINGS

FIG. 1 is a schematic representation of a relationship between a purchaser and consumer of fossil fuel and a recipient of a sponsored amount who performs an agricultural activity which contributes to reduction of carbon dioxide in the atmosphere in accordance with method of the present invention.

FIG. 2 is a schematic representation of a method of sponsoring reduction of carbon dioxide in the atmosphere by a purchaser and consumer of fossil fuel.

### DETAILED DESCRIPTION

Referring to the accompanying figure there is illustrated a reduction of harmful emissions sponsorship system and method generally indicated by reference numeral 10. The system and method 10 involves consumers 12 which purchase fossil fuels 14 who are provided an opportunity to sponsor activities 16 which contribute to the reduction of carbon dioxide in the atmosphere to offset the carbon dioxide released to the atmosphere when the fossil fuels purchased are consumed. In the preferred embodiment, the activities 16 comprise various activities in the field of agriculture which a farmer can implement to reduce carbon dioxide emissions in exchange for receiving a portion of the sponsored amount per unit area of land upon which the improved practices are implemented. Activities which can be implemented by the farmer include incorporating emissions from tractors and various internal combustion engines into the soil, the use of environmentally friendly fuels, for example hydrogen based fuels including photo fuel™ and the like. Various additional practices may also be implemented by the farmer according to the level of sponsorship per unit area of land.

In practice, a consumer determines the amount of fuel they are likely to consume which in turn determines the amount of carbon dioxide they are likely to be responsible for emitting into the atmosphere. A sponsorship amount is determined which corresponds to the funding required to implement better agricultural activities on a unit area of land which would effectively reduce the amount of carbon dioxide released to the atmosphere by an amount which corresponds to the expected amount of carbon dioxide generated from the consumption of the fossil fuel. The consumer then receives an account with points representing the sponsored amount. Points are debited from the account as a portion of the overall fuel amount expected over a season is purchased. The points are debited at the point of purchase of each portion of the overall fuel amount where a portion comprises for example a gas tank of a car of the purchaser. The account can be managed over the internet through a suitable interface by the consumer. At the point of sale, the points can be readily debited by use of a credit card type device. Each season the consumer re-estimates their consumption of fossil fuels and sponsors an appropriate amount which is given to the farmer. If an amount of fossil fuel is consumed which is greater than the sponsored amount, the consumer has the option of increasing the amount sponsored to a particular sponsored unit area of land. The farmer then has more funds available to him to increase the level of carbon dioxide reducing activities on the unit area of land.

As described herein, the present invention relates generally to a marketing idea to fund agriculture or any other industry that can have a large impact on green house gas emission levels. Documentable atmospheric CO2 scrubbers or using emissions for other useful purpose could also be included in this marketing idea. Influencing the plants in agriculture to maximize their natural ability to photosynthesize greater amounts of CO2 is done in some embodiments by incorporating emissions into the soil when practicing this method. Greenhouse gases are used in place of polluting elements that change the plants ability to photosynthesize CO2.

The marketing idea is a consumer level CO2 Exchange™ emitter to scrubber. When one gallon of fossil fuel is oxidized it releases approximately 20 lbs of CO2 into the atmosphere. As the consumer continues to use more fossil fuels the atmosphere CO2 has risen. Agriculture is one of the only manageable solar filters of CO2 that can be changed by a management practice. This takes scientific researchers, change of equipment, and this all takes time and money that needs to be funded through a public sponsorship. Agriculture can influence plants to be more effective at photosynthesizing CO2 by not providing the plants fossil fuel based fertilizers salts that change the carbon path in the plant to not store as much carbon in the soil or feed micro-organisms. Agriculture today is relying heavily on fossil fuel and fertilizer salts that are produced or mined with fossil fuel to produce our food and photo fuels.

The system and method according to the present invention are generally referred to herein as the Bio-Agtive™ CO2 Exchange™. The following details relate to the present invention: i) Public sponsorship user of fossil fuels emitting CO2 and green house gasses; ii) One gallon fossil fuel emits approximately 20 lbs CO2×500 gallons=10,000 lbs CO2; and iii) One acre producing 1.5 tons above ground plant matter would remove more than 10,000 lbs CO2 from the atmosphere.

The licensee using the Bio-Agtive™ system and method incorporates their emissions into the soil. Emissions are used as bio-fertilizer that allows the plants to maximize CO2 intake. This bio-chemically synthesizes back nutrients to the plant without any fossil fuel involved; only energy from the sun and emissions support the plant.

The public voluntarily sponsors one Bio-Agtive™ Acre at, for instance, $100.00 or $0.01 per lbs CO2 or $0.20 per gallon for fossil fuel. As the sponsor purchases fuel the sponsored Bio-Agtive™ CO2 equivalent credit would be debited from the account. It would be like a loyalty card swiped every time fuel is purchased. When the acre is maxed out the responsible sponsor could sponsor the Bio-Agtive™ Acre to go to a higher level of management to offset more emissions. Every year or season would be a new card. There will be an internet access to an account that would allow the sponsor to be able to look at the account and history to avoid maxing out the acre that is photosynthesizing the fossil fuel emissions back to photo energy, and also they could learn about the Bio-Agtive™ farms that are practicing sustainable farming that they are supporting.

This marketing method will be effective at helping fossil fuel consumers to become aware that someone out there has to get better at removing the green house gasses emitted, and they also need to become energy efficient.

Agriculture has a long way to go to become energy self sufficient. We are relying on fossil fuels to feed the world and now starting to fuel the world, using fossil fuels to make photo fuel this can be inefficient. Today fossil fuel powers the horsepower, fixates the nitrogen, mines the minerals, and transports all the products only to slow down the plants ability to photosynthesize. To become efficient we need to return to our own photo fuel to power agriculture like we did 100 years ago. Relying on the suns energy maximizing photosynthesis allows plants to clean up the atmosphere. By using the energy in the internal combustion engine that moves the equipment, the oxidation of combustion can also fertilize the soil as a bio-stimulant that increases carbon flow through the plant cleaning the atmosphere and making photo fuel.

As described herein, the Bio-Agtive™ CO2 Fuel Exchange marketing method operates generally as follows. A consumer of fossil fuels for transportation voluntarily sponsors one Bio-Agtive™ CO2 Exchange™ Acre. The base CO2 is 10,000 lbs. As consumer purchases fossil fuels, the CO2 credit purchased is used up. If the consumer goes over the 10,000 lbs CO2 extra offset credits can be applied to the card, and thereby to the acre. This funds the Bio-Agtive™ licensee to manage the acre to higher levels of atmospheric CO2 scrubbing or photosynthesis, for instance the % photo fuel in blend used for transportation would be exempt from exchange.

Other Bio-Agtive™ CO2 Exchange™ Levels are as follows:

#1. Base level emissions incorporated into soil when seeding or minimum tillage;

#2. Burn 10% to 100% photo fuel in the tractor or machinery;

#3. No salts applied to soil at seeding time only used in crop when needed as indicated by testing;

#4. Managing plants shoot to root ratio to favour roots;

#5. Different crops and genetic varieties can remove more CO2 per acre;

#6. Irrigated crops can exchange large tons of CO2; and

#7. Other agricultural equipment development such as irrigation motors, combines, swather, sprayers, forage harvesters and even lawn mowers gulf courses could be sponsored to change.

The sponsorship funds are used, for example; 20% to manage the program and for system R&D, with the remaining 80% going to the farmer or end-user organization contributing to the reduction of CO2 in the atmosphere.

The method described herein is most effective at funding changes our society needs to help reverse Global Warming. Agriculture is a major management tool available to reverse Climate Change by increasing photosynthesis and reducing farm fossil fuel inputs.

Personal responsibility for Greenhouse Gases (GhG's) is what the method of the present invention intends to accomplish. Enlightened consumers want effective change, and farmers according to the present invention remove carbon dioxide effectively by growing crops in a sustainable way. By sponsoring a reduction of carbon dioxide as described herein, a licensed, verified, acre of crop is sponsored by an individual which can in turn see the sponsored acre on a suitable internet interface.

Existing carbon and carbon dioxide markets don't provide any incentive to farmers to properly manage the carbon they grow. Climate exchanges and governments treat farmers who are trying to make a difference the same way they treat farmers who could care less. The system of the present invention rewards farmers according to their level of carbon management. Accordingly the more best practices they use and the more fossil fuel cuts they make, the more sponsored amounts they receive.

In an exemplary calculation, if a consumer burns 500 U.S. gallons of gasoline, at 20 pounds of CO2 per gallon, approximately 10,000 pounds (or 5 tons) of CO2 are released to the atmosphere. Typically it only takes 1 acre of crop on average to take 4.95 tons of CO2 out of the air. This calculation approximates the connection between a consumer of fossil fuel and an acre of crop. Accordingly, the present invention allows consumers to cover their carbon footprint from vehicle emissions and any other CO2 emissions. The exchange method of the present invention offers an opportunity to exchange emissions and promote agricultural changes the world needs to combat Climate Change.

According to the present exchange method, farmers submit their farm data of ter each harvest to a managing group which very conservatively calculates the amount of carbon dioxide removed from the atmosphere by the agricultural practices being funded by sponsorship on each acre. This information is made available to persons sponsoring towards the method, along with a satellite image of that parcel of land. Persons submitting sponsored amounts can also be contacted by the person conducting agricultural activities contributing to the reduction of carbon dioxide in the atmosphere.

Typically some of the amount sponsored into the present exchange method goes toward independent research into sustainable farming practices and to internal research and development of technology for incorporating exhaust emissions into the soil.

The present exchange method involves consumers of fossil fuel sponsoring an acre instead of simply buying a carbon offset for several reasons. People need to realize that crops really do immediately remove CO2 from the atmosphere in a more controlled, consistent way than any forest or far-off carbon offset project. Ideally people may come to realize that crops they're driving by are part of the solution to global warming, and that if every farmer around the globe utilized best practices it could make a huge impact on Global Warming. Further, the present exchange method encourages sponsors to commit to at least an annual accounting of the CO2 they produce, and then do something about it. Use of an account also allows sponsors to accurately record, track, and mitigate the carbon dioxide they create in your everyday life.

As described herein, the present invention relates to a system and method for motivating individuals to voluntarily sponsor a change in agricultural activities which contributes to reduction of carbon dioxide in the atmosphere to offset the consumption of fossil fuels by the individuals.

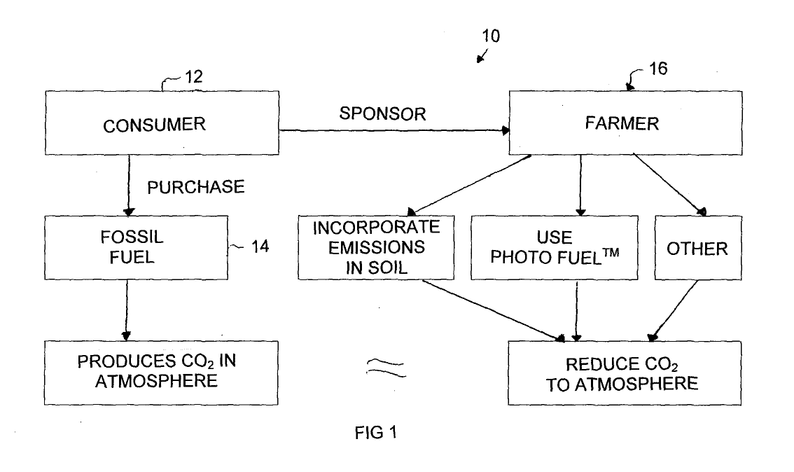

As shown in FIG. 1, a relationship is represented schematically between a consumer of fossil fuels, for example persons purchasing fuel for use in a vehicle, and persons performing activities which reduce carbon dioxide in the atmosphere, for example farmers practicing better agricultural practices. According to the present exchange method, consumers 12 who purchase fossil fuel 14 are identified as being responsible for a designated amount of carbon dioxide being produced in the atmosphere. A suitable sponsored amount is determined to be sent to a farmer 16 who incorporates better agricultural practices using the sponsored amount to effectively contribute to a reduction in carbon dioxide in the atmosphere which is approximately equal to the prescribed amount of carbon dioxide released into the atmosphere as a result of the consumption of the fossil fuel purchased by the consumer.

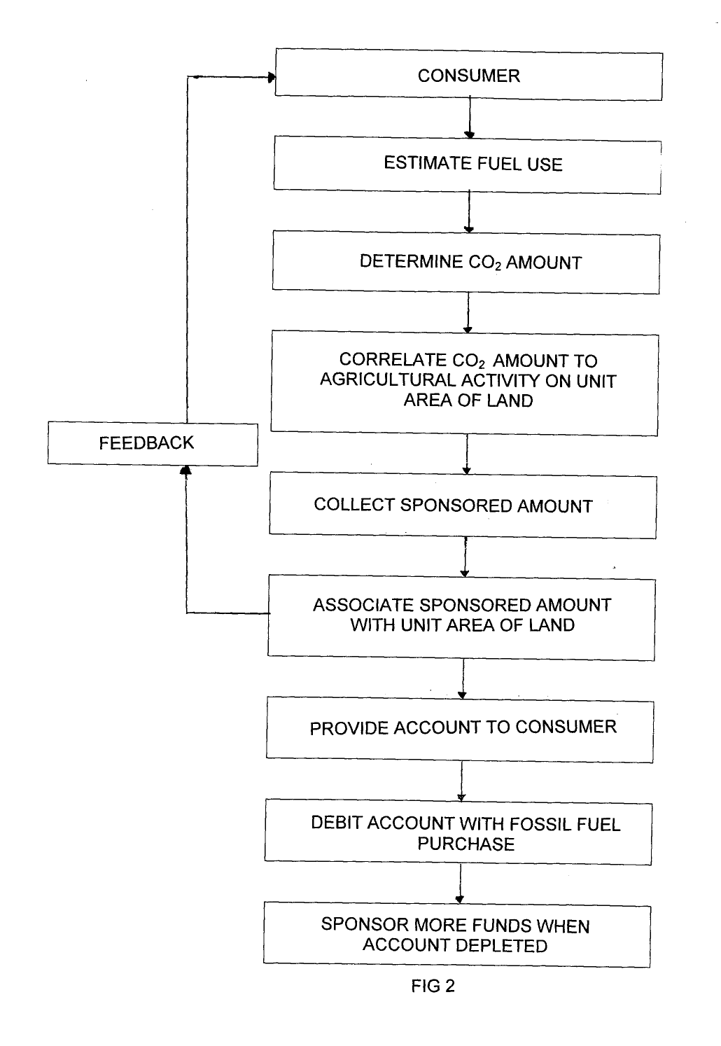

As shown in further detail in FIG. 2, the present method of sponsoring a reduction in carbon dioxide in the atmosphere is schematically represented. A consumer 12 initially estimates the amount of fossil fuel use expected over a given period of time, for example a growing season or for a full calendar year corresponding to a particular growing season. The amount of carbon dioxide resulting in the atmosphere as a result of the combustion of that estimated fossil fuel amount is then determined and correlated to an agricultural activity on a unit area of land which contributes to reduction of carbon dioxide in the atmosphere by an equal amount.

A sponsored amount of funds is then determined which corresponds to funding the agricultural activity on the unit area of land which offsets the carbon produced by consumption of the fossil fuels. The collected sponsored amount from the sponsor or consumer of fossil fuels is then associated with the unit area of land so that the consumer better identifies with how their sponsored funds are being spent.

In exchange for the sponsored amount, the consumer receives an account with points corresponding to the estimated fossil fuel to be purchased over the given period of time. As the consumer purchases portions of the overall estimated fossil fuel amount, for example when purchasing fuel for a vehicle, a corresponding or proportional amount of points are debited from the account of the consumer. Typically the points are debited at a point of purchase of fuel either by swiping a credit card type device associated with the account or by the user entering fuel purchased on an internet interface which then debits the corresponding amount of points from the account. If the user consumes more fossil fuel than estimated, and the account no longer has any points in it, the consumer is given the opportunity to sponsor further funds towards the same acre or to sponsor an additional acre or unit of land upon which agricultural activity is to be performed.

When associating a unit area of land with the sponsored amount, the user may be provided a choice to select between a plurality of available units of land through an internet interface in which information about each area of land is provided back to the user selecting where their sponsored amount will be associated. Information may include the type of crop on the land, the type of agricultural practices or activity being performed on the land which contributes to a reduction in carbon dioxide in the atmosphere and or other statistical information including the location of the land and photos of the land. A management party separate from the consumer of fossil fuels or the farmer who is a recipient of the sponsored amount and who performs the agricultural activities which reduce carbon dioxide in the atmosphere, performs a verification of the crop type, other detailed information about the unit area of land being sponsored and the amount of carbon dioxide being effectively reduced in the atmosphere as a result of the agricultural activities on that area of land.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of sponsoring reduction of carbon dioxide in the atmosphere, the method comprising:
identifying at least one activity which reduces carbon dioxide in the atmosphere;
collecting a sponsored amount from a purchaser of a fossil fuel; and
using at least a portion of the sponsored amount to fund at least a portion of said at least one activity.

2. (canceled)

3. The method according to claim 1 including associating the sponsored amount with a portion of said at least one activity and providing information relating to said at least one activity associated with the sponsored amount to the purchaser.

4. (canceled)

5. (canceled)

6. The method according to claim 1 including collecting the sponsored amount to correspond with an amount of fossil fuel consumed in a vehicle over a prescribed period of time wherein the prescribed period of time corresponds to a growing season.

7. The method according to claim 1 wherein the sponsored amount is voluntary contributed by the purchaser.

8. (canceled)

9. The method according to claim 1 wherein the purchaser purchases a fuel amount of fuel for consumption, the fuel amount being correlated to a given amount of carbon dioxide when consumed and wherein the method includes determining a prescribed level of said at least one activity required to reduce carbon dioxide in the atmosphere by the given amount and arranging the sponsored amount to fund said prescribed level of said at least one activity.

10. The method according to claim 1 including debiting the sponsored amount from the purchaser at a point of sale of the fuel being purchased.

11. The method according to claim 1 wherein the sponsored amount corresponds to a fuel amount in which only a portion of the fuel amount is purchased by the purchaser at a given time.

12. The method according to claim 1 including identifying an agricultural activity which contributes to a reduction in carbon dioxide in the atmosphere, using at least a portion of the sponsored amount to fund at least a portion of said agricultural activity.

13. (canceled)

14. The method according to claim 12 including associating the sponsored amount with a unit area of land which is used for agriculture.

15. (canceled)

16. (canceled)

17. (canceled)

18. The method according to claim 14 including providing information relating to said unit area of land to the purchaser.

19. (canceled)

20. (canceled)

21. The method according to claim 12 including the purchaser selecting a unit area of land to be associated with said at least one activity among a plurality of unit areas of land.

22. The method according to claim 21 including rating the plurality of unit areas of land according to a potential contribution in reduction of carbon dioxide by the land.

23. (canceled)

24. (canceled)

25. The method according to claim 21 including providing an internet interface through which the purchaser selects the unit area of land.

26. The method according to claim 12 wherein the agricultural activity comprises incorporating exhaust emissions from agricultural equipment into the soil.

27. The method according to claim 12 wherein the agricultural activity comprises use of fuel from renewable energy sources in agricultural equipment.

28. (canceled)

29. (canceled)

30. (canceled)

31. The method according to claim 1 including providing the purchaser with points in an account in exchange for the sponsored amount and debiting points from the account of the purchaser upon purchasing the fossil fuel.

32. The method according to claim 31 including debiting the points from the account at a point of sale of the fossil fuel.

33. The method according to claim 31 including providing the purchaser with a debit card and debiting points from the account by swiping the debit card at a point of purchase of the fossil fuel.

34. The method according to claim 31 including updating points credited on the account by increasing the sponsored amount through an internet interface.

35. The method according to claim 31 including updating points debited on the account according to an amount of fossil fuel purchased through an internet interface.

36.-59. (canceled)
